(19) United States
(12) Patent Application Publication
(10) Pub. No.: US 2008/0187641 A1
(43) Pub. Date: Aug. 7, 2008

(54) Sonora style corn tortillas

(76) Inventor: Anthony A. Madird, Sacramento, CA (US)

Correspondence Address: Andres A. Madrid, 6260 Belleau Wood Ln. #2, Sacramento, CA, 95822, US

(21) Appl. No.: 11/701,513

(22) Filed: Feb. 2, 2007

(51) Int. Cl. A21D 13/06

(52) U.S. Cl. 426/549

(57) ABSTRACT

This invention is a corn tortilla dough recipe which results in a corn tortilla which is more pliable, flexible and less suspect to breakage than traditional corn tortillas and can be manufactured in the same manor as flour tortillas with a mixture of 65-70 percent Corn flour (conventional or organic), 10-20 percent gluten (conventional or organic) or wheat flour (conventional or organic), 10-20 percent other incidental ingredients to act as preservative, leavening agent and flavoring.

This application claims priority of Provisional Application No. 60/755/970 filed on Jan. 4, 2006

References Cited

| | | |
|---|---|---|
| U.S. Pat. No. 3,792,174 | February 1974 | Duarte et al. |
| U.S. Pat. No. 4,241,106 | December 1980 | Tims |
| U.S. Pat. No. 3,653,915 | April 1972 | Rubio |
| U.S. Pat. No. 3,655,385 | April 1972 | Rubio |
| U.S. Pat. No. 3,672,912 | June 1972 | Rubio |
| U.S. Pat. No. 3,687,685 | August 1972 | Rubio |
| U.S. Pat. No. 3,690,893 | September 1972 | Rubio |
| U.S. Pat. No. 3,694,224 | September 1972 | Rubio |
| U.S. Pat. No. 3,709,696 | January 1973 | Rubio |
| U.S. Pat. No. 3,730,732 | May 1973 | Rubio |
| U.S. Pat. No. 3,853,998 | December 1974 | Rubio |
| U.S. Pat. No. 3,859,449 | January 1975 | Rubio |
| U.S. Pat. No. 4,109,018 | August 1978 | Thompson |
| U.S. Pat. No. 3,574,634 | April 1971 | Singer |
| U.S. Pat. No. 6,764,699 | July 2004 | Rubio |
| U.S. Pat. No. 5,006,358 | April 1991 | Ribio |

### STATEMENT OF FEDERAL FUNDING

Non applicable

### BACKGROUND OF THE INVENTION

This invention relates to corn tortillas which are manufactured using the same methods and machinery used in the mass production of flour tortillas. Specifically, manufactures of both flour and corn tortillas have had to have two separate “lines” (sets of machinery) to manufacture each type of tortilla. This recipe for corn flour dough eliminates the need for a separate manufacturing process which is currently necessary to manufacture corn tortillas. The resulting corn tortilla is softer, more pliable, and flexible and less suspect to breakage than traditional corn tortillas.

Tortillas are conventionally made from whole corn kernels which are treated with alkali and then ground to a flour. The flour is combined with water to form unleavened dough from which thin flat discs are formed and heated. It is also known to prepare tortillas from wheat flour as taught, for example, in U.S. Pat. No. 3,792,174.

Tortillas are generally used in preparing foods such as tacos, burritos, enchiladas, etch, which require that heated tortillas be folded over or rolled around a filling of diverse food materials. Although a considerable degree of crispness is desirable in tortillas, they should preferably remain sufficiently pliable upon storage to withstand folding or rolling without substantial cracking or breaking occurring in the areas of stress. (U.S. Pat. No. 4,241,106) This invention removes the need to heat the corn tortilla prior to manipulation to make the above dishes.

### DISCUSSION OF THE PRIOR ART

There are a number of patents relating to tortillas and processes for preparing the same. The problem of retarding staling and maintaining flexibility in stored tortillas is dealt with in U.S. Pat. Nos. 3,653,915; 3,655,385; 3,672,912; 3,687,685; 3,690,893; 3,694,224; and 3,709,696. These patents teach incorporating into dough prepared from nixtamilized corn or corn flour various materials, e.g., mono- and diglycerides, epichlorohydrin, hydrophilic gums, borates or aluminates, inorganic gels, e.g., aluminum hydroxide, etc. U.S. Pat. No. 3,730,732 relates to a process for increasing the yield of dough and tortillas as well as retarding microbiological spoilage therein by adding water soluble alkaline substances, e.g., alkali metal hydroxides and bicarbonates, to a nixtamilized corn dough. U.S. Pat. No. 3,853,998 is directed to retarding microbiological spoilage of tortillas by incorporating alkyl esters of para-hydroxybenzoic acid into corn based dough. U.S. Pat. No. 3,859,449 is concerned with retarding or preventing microbiological spoilage of tortillas by adding acetic or propionic acid or their anhydrides to corn flour dough. U.S. Pat. No. 3,792,174 relates to a dry mix for preparing tortillas comprising wheat flour, baking powder and other materials. There are also a number of patents relating to the use of hydrophilic colloids and/or gluten in preparing baked goods. U.S. Pat. No. 4,109,018 relates to a dough composition for making low calorie diet bread. The dough comprises wheat flour and a number of other materials including vital wheat gluten and a hydrophilic gum. U.S. Pat. No. 3,574,634 is directed to a low-carbohydrate dough consisting of gluten flour containing vital gluten, a cellulosic filler, vegetable gum and water.

### SUMMARY OF THE INVENTION

The object of this invention is to provide a corn tortilla which is more pliable, flexible and less suspect to breakage than traditional corn tortillas and can be manufactured in the same manor as flour tortillas.

Corn tortillas which are more pliable, flexible and less suspect to breakage than traditional corn tortillas can be manufactured by using a mixture of 65-70 percent Corn flour (conventional or organic), 10-20 percent gluten (conventional or organic) or wheat flour (conventional or organic), and 10-20 percent other incidental ingredients to act as preservative, leavening agent and flavoring. Using this method also allows the manufacture of corn tortillas on equipment usually reserved for the production of flour tortillas.

### DETAILED DESCRIPTION OF INVENTION

Traditionally the manufacture of corn tortillas requires the corn dough to be moved and placed in a feeder-sheeting-former-oven machine (Rodotec Ecologica-100, Tecnomaiz-Gruma, Monterrey, N.L. Mexico). A feed screw moves the dough horizontally into a manifold which pushes it through a slot. The plastic dough is fed onto a pair of smooth rollers, one rotating counterclockwise and the other clockwise. The gap between the rollers is adjustable and the thickness of the dough sheet determines the final product weight and its diameter. The flat disks of dough pieces leave the front roller on a discharge belt, which feeds directly into the oven. A natural gas fired-oven is used to bake sheeted corn-dough into tortillas. They are baked at temperatures ranging from 300 degrees C. to 330 degrees C. in a multiple-pass three-tier oven in which the residence varies from 20-40 seconds. (U.S. Pat. No. 6,764,699)

A process for forming wheat flour tortillas is the so-called pressing method and apparatus. Dough balls are formed in a divider-rounder, proofed in a proofer cabinet or an automatic proofer, and fed automatically or manually onto a conveyor which carries 6 to 12 dough balls at a time into position between the heated platens of a tortilla press. To attain a reasonable volume of production, a large amount of heat must be imparted to the tortillas by the platens to overcome their inherent tendency to resume their original shape, and thereby to thicken and shrink in size circumferentially. Therefore, the associated conveyor belt must possess a high heat tolerance. For those reasons, and to provide belts with sufficient, properties of non-adherence, strength, flexibility and durability, conveyor belts in common use consist of a woven fiberglass yarn base with a Teflon covering. When a batch of dough balls has been properly positioned between the press platens, the conveyor is stopped and the press is closed on the dough balls for about one second, which squeezes the balls into round, “pancake” shaped tortillas that are then transferred into an oven for baking. The heating of the tortillas during pressing stabilizes them in shape and size. The melting of the shortening or the oil present in the dough precludes the need for dusting flour and the result is a superior, better tasting product. However, having to start and stop the conveyor each time a new group of dough balls is presented by it to the press severely limits the output of such apparatus to the range of from about 350 to 500 dozen 6″-8″ tortillas per hour. (U.S. Pat. No. 5,006,358)

The invention detailed in this patent allows for the manufacture of corn tortillas using the latter “pressing method and apparatus”. Thus only one set of machinery is needed to produce both flour and corn tortillas. The corn tortilla dough which has this ability consists of 65-70 percent Corn flour (conventional or organic), 10-20 percent gluten (conventional or organic) or wheat flour (conventional or organic), 10-20 percent other incidental ingredients to act as preservative, leavening agents and flavoring.

We claim:

1. A method for improving the corn tortilla which results in a corn tortilla which is more pliable, flexible and less suspect to breakage than traditional corn tortillas.

2. A recipe for corn flour dough for the production of corn tortillas which can be machined, portioned and baked using the same methods and equipment that are used for the production of flour tortillas.

3. A corn tortilla as set forth in claim 1 which can be rolled with a ¼^{th} inches diameter opening at 40 degrees Fahrenheit without breaking or cracking.

4. A corn tortilla as set forth in claim 1 which can be folded to an internal angel of 15 degrees without breaking or cracking.

5. A corn tortilla as set forth in claim 2 made from a dough mixture comprising of the following: 65-70 percent Corn flour (conventional or organic), 10-20 percent gluten (conventional or organic) or processed wheat flour (conventional or organic), 10-20 percent other incidental ingredients to act as preservative, leavening agent and flavoring.

6. A corn tortilla dough as set forth in claim 2 which can be manufactured using standard methods for machine producing traditional flour tortillas including the use of a divider-rounder to form dough balls, which are then fed automatically or manually onto a conveyor which carries 6 to 12 dough balls at a time into position between the heated platens of a tortilla press. The resulting pressed dough is then transferred into an oven for baking.

7. A corn tortilla dough as set forth in claim 2 which results in a corn tortilla which can be manufactured in the same manor as traditional flour tortillas and can also be die cut to the desired diameter.
